(19) United States
(12) Patent Application Publication
(10) Pub. No.: US 2011/0066898 A1
(43) Pub. Date: Mar. 17, 2011

(54) PREDICTIVE ANALYSIS METHOD FOR IMPROVING AND EXPEDITING REALIZATION OF SYSTEM SAFETY, AVAILABILITY AND COST PERFORMANCE INCREASES

(75) Inventors: Francis Xavier MCRORY, Warner Robins, GA (US); Rogelio SAUCEDO, Bonaire, GA (US)

(73) Assignee: Ki Ho Military Acquisition Consulting, Inc., Fairfax, VA (US)

(21) Appl. No.: 12/858,021

(22) Filed: Aug. 17, 2010

Related U.S. Application Data
(60) Provisional application No. 61/235,820, filed on Aug. 21, 2009.

(51) Int. Cl. G06F 11/28

(52) U.S. Cl. 714/47.3; 714/E11.178

(57) ABSTRACT

Predictive analysis systems and methods use and correlate data from historic events to identify trends and develop corrective maintenance and logistics actions in various technology areas, such as the transportation industry, the manufacturing industry, or any other suitable industry that experiences equipment failure. The predictive analysis method and also determines the adequacy and compliance of the requirements prior to the failure of a system in order to preemptively minimize and eliminate these negative outcomes. Current failure trends may be evaluated for one or several components of a given system, which may be the frequency of incidence of failure of one or more components of the system. Engineering instructions for repair may also be evaluated when a failure of one or more components of the system has taken place. On the basis of this information, future failure trends may be forecast and supply channels and maintenance and repair protocols may be updated in order to decrease component failure.

This application claims priority from provisional U.S. patent application No. 61/235,820, titled “Predictive Analysis Method for Improving and Expediting Realizatino of System Safety, Availability and Cost Performance Increases,” filed on Aug. 21, 2009, and incorporated herein by reference in its entirety.

### BACKGROUND

1. Field of the Invention

Aspects of this invention relate to a method and process for optimizing system safety, availability and cost performance. More particularly, aspects of the current invention relate to optimizing systems performance in various technology areas such as transportation, industry and any other appropriate areas that experience equipment deterioration and/or failure.

2. Background Art

Related art system optimization methods for improving system reliability include, for example, Total Productive Maintenance (TPM), Reliability Centered Maintenance (RCM), and Condition Based Maintenance (CBM). The general concepts and approaches for each of these methods are very similar, focusing on maintenance processes and individual component performance improvement through the analysis of past performance data. Other techniques, such as Revised Failure Modes Effects and Criticality Analysis (FMECAs), are based on historical maintenance data.

In general, realization of expected improvements using traditional reliability analysis methods are either not achieved on time, or not achieved to the extent expected. Traditional reliability improvement methods generally do not fully consider logistics aspects, such as parts projections, budgeting, purchase plans, lead time and other like elements affecting system or fleet availability, support cost and improvement implementation. Additionally, future failure trends for items with limited or non-existing failure history cannot be accurately predicted through analysis of historical maintenance data alone. Revised FMECAs based on historical maintenance data alone cannot accurately predict future failures and outcomes for items with limited or no in-service failure history.

U.S. Patent Application Publication No. 2005/0143956 to Wayne R. Long focuses on utilizing computer systems for determining a theoretical useful life for each component involved in a duty profile, the theoretical useful life being based on component useful life data under the specified operating conditions.

U.S. Patent Application Publication No. 2003/0004765 to Bobo Wiegand proposes a modularized maintenance system and provides a feedback control system, in which the efficiency of the maintenance work is monitored and recorded. The method and system of Wiegand adjust the maintenance system through the modification of strategies, methods and/or equipment.

U.S. Patent Application Publication No. 2004/0176929 to Dirk Joubert and Klaus Kruppel proposes a method and system for the maintenance and monitoring of equipment and machinery by monitoring equipment and machinery conditions, maximizing equipment and monitoring utilization or disposition, so as to maximize the net effective value.

### SUMMARY

The traceability of engineering requirements for maintenance, logistics and other functional support documentation may sometimes uncover inadequacies resulting in the sub-optimization of system performance and durability. Such inadequacies may lead to system failure or premature degradation. Missing, inaccurate and/or unclear inspection instructions may lead to problems, such as non-compliance of the maintenance function within the intent of the engineering requirements. Under these conditions, expected or predictable system deterioration is not detected, and induced damage may occur. Inadequate requirements deployment generally manifests itself through system premature failure, unscheduled maintenance and unexpected demand for components, processes and infrastructure support. When these problems are finally uncovered, efforts to restore system functionality generally result in unexpected system downtime, which renders the system unavailable, and increases support costs.

The predictive analysis systems and methods, according to various aspects of the current invention, use and correlate data from previously recorded historic events to predicted future events, in an effort to identify trends and develop corrective maintenance and logistics actions in various technology areas, such as the transportation industry, the manufacturing industry, or any other appropriate industry that may experience equipment failure. The data analysis according to aspects of the current invention may include forecasting future failure trends of a system and its components, and the forecast of upcoming or future failure trends may lead to remedial measures such as, for example, updating of the supply channels for one or more parts of a system component, maintenance and/or repair protocols, maintenance/repair documentation and the like, in order to decrease component failure. The predictive analysis method according to aspects of this invention may also determine the adequacy and compliance of the requirements prior to the failure of a system, in order to preemptively minimize and eliminate these negative outcomes. According to aspects of the current invention, the predictive analysis method optimizes the performance of a given system in various industrial or technology areas, such as transportation, industry and/or any other appropriate areas that may experience equipment deterioration and/or failure.

Aspects of the current invention differ from the conventional techniques by considering data beyond traditional engineering and maintenance data, data relative to all functional support including requirements and performance parameters, logistics, procurement, contracting, repair, overhaul, packaging, handling, shipping, storage, and the like. Aspects of the current invention also differ from conventional techniques by performing Risk Priority Number (RPN) analyses and Failure Mode and Effects Analyses (FMEA) in order to further prioritize safety component analyses. Additionally, aspects of the current invention perform historical and predictive non-availability analyses across many or all functional support disciplines, instead of only considering maintenance and engineering data, for further component analysis prioritization, and identify looming safety and non-availability drivers that are not detected via traditional methods.

Aspects of the current invention perform correlation analyses among disparate data and information sets, instead of focusing on traditional markers in the engineering and maintenance disciplines, and this novel approach results in establishing non-availability trends and other adverse trends that would otherwise not readily be apparent and/or that would remain undetected using traditional techniques, such as Reliability Centered Maintenance (RCM) and other related art traditional methods. Aspects of the current invention perform intense and rigorous trace and deployment analyses for engineering, maintenance, logistics and other appropriate functional support discipline requirements to detect sources of induced or unintended damage that are not readily apparent using traditional methods.

Aspects of the current invention are particularly applicable for use with aging systems and fleets performing far beyond their original design service life, such as planes, boats, and the like, which has occurred increasingly over the last two decades. Aspects of this invention relate to requirements for deployment traceability and FMEAs for systems and fleets approaching the end of their original design life, which takes into consideration system and fleet age, and provides complete, efficient and feasible business and implementation solutions for improving system safety, availability and cost performance.

Aspects of the current invention expedite realization of expected cost increases via the forecasting of component and part failure and assist in anticipating demand trends, with an approach that is neither achievable nor considered in existing methods. Consideration and correlation of additional information and data not included in existing traditional reliability improvement methods may be accomplished by, for example, identifying previously undetected failure trends, emerging failure trends, and possible future failure trends. For example, existing maintenance and logistics support plans may be evaluated to determine the adequacy of these plans in order to address emerging and predicted failure trends. Revised plans may also be developed to minimize system downtime due to maintenance and replacement component non-availability, and to optimize cost performance, for example.

According to various aspects of the current invention, the effectiveness of maintenance and logistics support performance, downtime due to maintenance and non-availability of components, and cost over a specified interval can be measured in a number of system failures. In lieu of related art reliability methods, predictive analysis methods may also be implemented when set goals for these parameters are not met, in order to realize greater performance increases in a shorter time span. The predictive analysis method may include three processes: i) engineering requirements traceability and deployment for maintenance, logistics and other support function documentation, ii) evaluation and correlation of apparently disparate engineering, maintenance, logistics and other data sets, and iii) correlation of engineering, maintenance, logistics and other functional documentation instructions and requirements to corresponding performance data sets.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

FIG. 1 is a flow chart illustrating engineering requirements traceability for maintenance and logistics documentation and data, according to various aspects of the current invention;

FIG. 2 is a chart illustrating historical system failures, according to various aspects of the current invention;

FIG. 3 is a chart illustrating historical engineering assistance requests, according to various aspects of the current invention;

FIG. 4 is a chart correlating historical system failures with demand for unavailable components, according to various aspects of the current invention;

FIG. 5 is a chart correlating historical engineering assistance requests with demand for unavailable components, according to various aspects of the current invention;

FIG. 6 is a chart illustrating the number of component failures with respect to cumulative service time, according to various aspects of the current invention;

FIG. 7 presents an exemplary system diagram of various hardware components and other features, for use in accordance with an aspect of the present invention;

FIG. 8 is a block diagram of various exemplary system components, in accordance with an aspect of the present invention.

### DETAILED DESCRIPTION

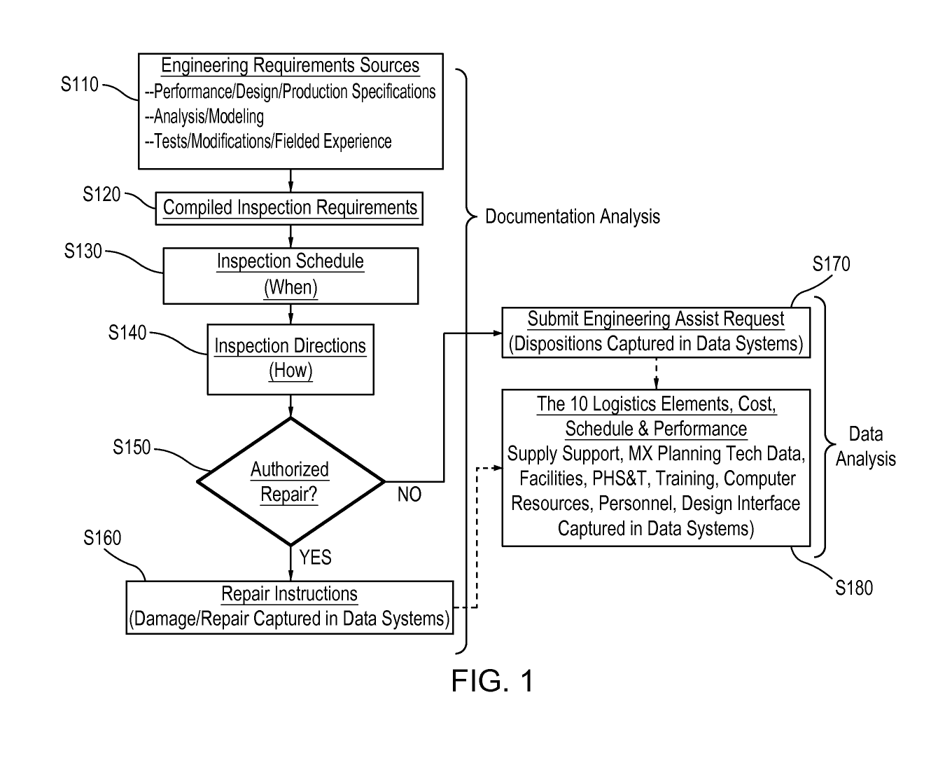

FIG. 1 is a flow chart illustrating a method of tracing and deploying of engineering requirements for maintenance, logistical and other functional support documentation and data analysis for a system, according to various aspects of the current invention. According to the flow chart illustrated in FIG. 1, current failure trends are evaluated for one or several components of a given system. The current failure trends may be the frequency of incidence of failure of one or more components of the system. Engineering instructions for repair may also be evaluated when a failure of one or more components of the system has taken place. FIG. 1 provides an exemplary overview of the predictive analysis method for various technology areas, such as the transportation industry, the manufacturing industry, or any other applicable industry that experiences equipment failure. According to various aspects of the current invention, the process starts in S110, where engineering requirement source documents are provided.

According to various aspects, the engineering requirement source documents for a given system may include i) specifications from system concept through development, prototype, test, production and fielding; ii) documents for management of the system, any subsystems within the system, and components of the system, the documents containing specific requirements for maintaining performance throughout the intended service life of the system based on testing, modeling and other analyses; iii) test reports; iv) analysis and modeling reports; v) updates based on field experience and system modifications; and vi) responses to maintenance, logistical and other requests for assistance from functional support technicians to correct deficiencies not addressed or authorized for repair at the technician level without engineering authorization. According to various aspects of the current invention, the above parameters are combined and processed in order to evaluate current failure trends, evaluate engineering instructions for repair and perform a preventive analysis as further indicated below. A result of this preventive analysis may be to predict failure of a given piece of equipment.

During S120, inspection requirements are compiled. In an aspect of this invention, inspection requirements may include the following parameters: i) a schedule of inspections, ii) maintenance tasks to be performed, iii) maintenance action data describing the inspections, findings and repairs completed, and iv) requests for engineering assistance for findings of damage. According to various aspects of the current invention, the above parameters are combined and processed in order to perform a preventive analysis, the result of which may be the ability to predict failure of a given piece of equipment or of a given system, including multiple pieces of equipment.

During S130, an inspection schedule is prepared according to various aspects. The inspection schedule may be in the form of an owner's manual, a shop manual or other equivalent document establishing timely requirements at the technician level for the system being monitored, with timely requirements including deadlines and milestones to be achieved in order to keep the system well maintained and in good working condition. In S140, the process according to aspects of this invention provides inspection directions, where the inspection directions may include specific maintenance tasks in the form of an owner's manual, shop manual or other equivalent documents establishing authorized and/or achievable repair requirements at the technician level for the system being monitored. In S150, the process initiates an inquiry to determine whether a repair is authorized. If a repair is authorized, then the process proceeds to S160, where repair instructions are provided to a technician or other operator, and the repair is carried out. At the conclusion of the authorized repair, a maintenance action report or data may be generated, the maintenance action data including a description of the inspections, findings and repairs that have been completed.

However, if the inquiry in S150 results in the determination that a repair is not authorized, which may be the case when a technician is confronted with a failure or deterioration condition that is not specifically addressed in a manual or other workshop documentation, for example, then the process proceeds to S170, where a data analysis is performed and where an engineering assist request may be placed when there is a finding of damage outside of the conventional scope of technician instructions or other authorized maintenance or repair actions. The data analysis may include evaluating current failure trends, and forecasting of future failure trends, based on the evaluation of the current failure trends. Forecasting future failure trends may lead, according to various aspects, to the updating of supply channels, maintenance and/or repair protocols, maintenance/repair documentation and the like, as shown below, in order to decrease component failure. According to various aspects, updating the supply channels and/or maintenance and repair protocols may lead to providing specific parts that may not be readily available, and the failure of which would result in significant system downtime. Accordingly, when a failure trend becomes noticeable, component parts that are traditionally not in great demand but that may be subjected to failure according to the failure forecast can be ordered and kept ready to be used when the predicted failure occurs. Similarly, maintenance protocols may be changed in order to prevent system failure as soon as a failure trend becomes noticeable. Updating maintenance protocols can be performed as explained below.

When an engineering assist request is made in S170, data analysis is performed during S180 in the form of a plurality of logistics elements to be implemented, one result of which may be the establishment of a possible failure trend, and thus failure prediction. According to various aspects of the current invention, the logistics requirements and data may include: i) technical data including illustrated parts breakdown manuals or equivalent documents describing systems, subsystems and components in enough detail for technicians to complete replacement ordering, induction for repair and/or overhaul, condemnation or other related supply chain activity; ii) identification of required facilities for system storage, shipping, repair, and operations; iii) packaging, handling and storage requirements at many or all assembly levels; iv) training requirements for maintenance, operations, supply support and applicable other functional support activities; v) identification of computer support resources; vi) identification of personnel resources required for system operation and support; vii) system design interfaces with other systems; viii) system support and test equipment; ix) maintenance planning; and x) supply support. At the conclusion of the process, this data may be gathered and combined in order to predict future failure, such as a catastrophic failure, or degradation, of one or more components of the system. The type of data that may be gathered and that provide an indication as to an imminent failure is further described below.

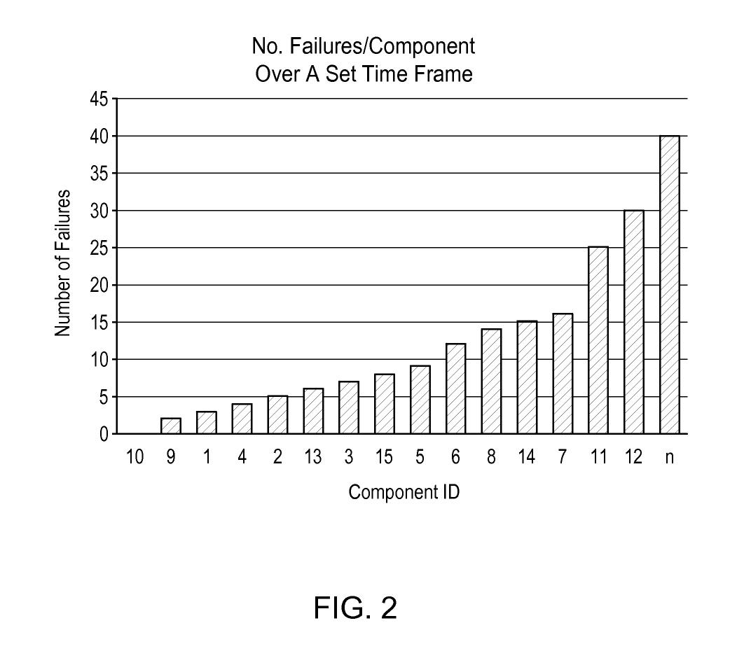

According to various aspects, evaluating the current failure trends of one or more components of the system, and evaluating engineering instructions for repair is described below with respect to FIGS. 2-6. FIG. 2 is a chart illustrating historical system failures that may be used in the evaluation of current failure trends, according to various aspects of the current invention. FIG. 2 is a representative chart of historical failures at the component level for components of a system authorized for repair at the maintenance technician level in various technology or industrial areas such as the transportation industry, the manufacturing industry or any other appropriate industry that experiences equipment failure. Maintenance items of components authorized for repair, or tasks to perform during maintenance, are normally identified during scheduled maintenance intervals. However, high incidences of failure may be attributable to inadequate maintenance documentation, for example, in addition to the inherent behavior of a system component. The chart illustrated in FIG. 2 sets priorities for performing additional data mining and analysis on specific items. In other words, as the number of failures increases, as indicated, by component ID Nos. 7, 11, and 12, catastrophic failure becomes more likely or imminent. As a result of this analysis of an imminent catastrophic failure, a higher effort of maintenance and monitoring of these components may be ordered and performed in order to prevent the predicted catastrophic failure. For example, supply channels may be altered in order to provide component parts that are not readily available, and the absence of which may cause significant downtime. Accordingly, when a failure trend is discovered and a failure of one or more system components is forecast, bringing component parts that are seldom utilized but that have been predicted to fail would reduce or eliminate system downtime in case of failure of one or more of those component parts. According to various aspects of the current invention, the data analysis described above with respect to FIG. 2 allows for the prediction of an imminent failure.

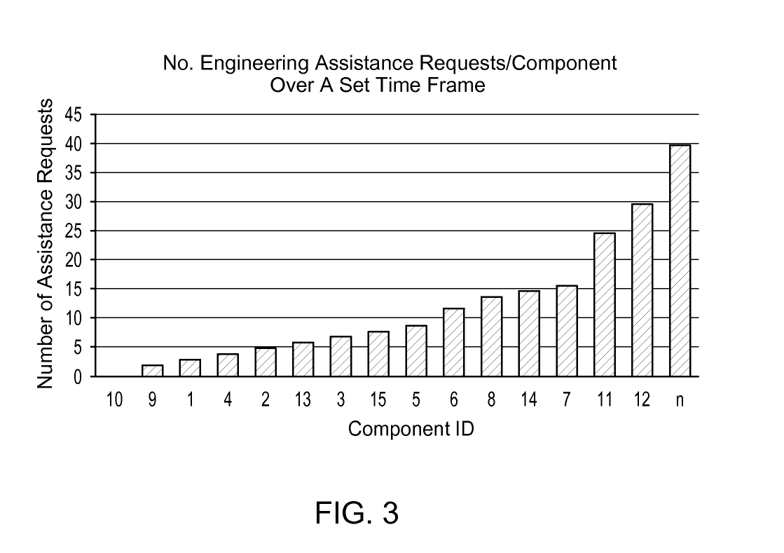

FIG. 3 is a chart illustrating engineering assistance requests that may be used in the evaluation of engineering instructions for repair, according to various aspects of the current invention, as applied to various technology areas such as the transportation industry, the manufacturing industry or any other industry that experiences equipment failure. Engineering assistance requests may be generated from maintenance, logistics and other functional support technicians when they are confronted with a failure or condition that is not addressed in published documentation, or is unauthorized for corrective action at the technician level without approval from an engineering or equivalent authority. Some of these items may be identified during scheduled maintenance intervals, while others may cause the system to become unexpectedly inoperable, which leads to unscheduled maintenance and a resulting unexpected and costly downtime. Unscheduled maintenance events generally result in negative system downtime, and represent a trend indication of items failing unexpectedly, or failing on a repeated basis. In general, unscheduled maintenance events are indicators of emerging and potential future failures and component demand trends. The chart illustrated in FIG. 3 sets priorities for performing additional data mining and analysis on specific items. In other words, as the number of engineering assistance requests increases, as indicated by component ID No. 7, 11, and 12, for example, then catastrophic failure is more likely or imminent, and a higher effort of maintenance and monitoring of these components may be ordered and performed in order to prevent the predicted catastrophic failure. For example, supply channels may be altered in order to provide component parts that are not readily available, and the absence of which may cause significant downtime. Accordingly, when a failure trend is discovered and a failure of one or more system components is forecast, bringing component parts that are seldom utilized but that have been predicted to fail would reduce or eliminate system downtime in case of failure of one or more of those component parts. It should be noted that the chart illustrated in FIG. 3 can be correlated to the chart illustrated in FIG. 2, in that a larger number of failures generally correlate to a larger number of assistance requests.

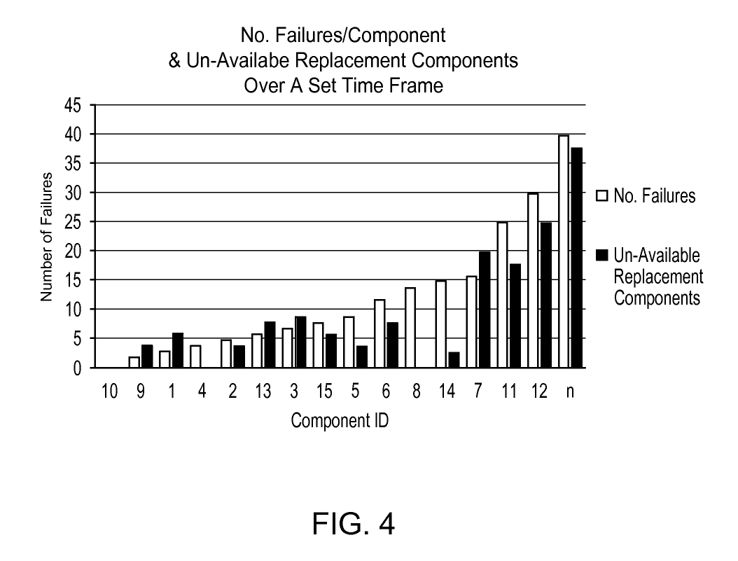

FIG. 4 is a chart correlating historical system failures with the demand for components that are unavailable that may be used in the evaluation of current failure trends, according to various aspects of the current invention. FIG. 4 may also represent a correlation between historical failures at the component level authorized for repair at the maintenance technician level, and demand for unavailable components for various technology areas such as the transportation industry, the manufacturing industry or any other appropriate industry that experiences equipment failure. Unavailable components are generally components that are not often the subject of failure and that are not part of the conventional stream of replacement parts. The chart illustrated in FIG. 4 is similar to the charts illustrated in FIGS. 2 and 3, in that it shows an exponential increase of failures for various components. For each component ID, both the number of failures and the number of unavailable replacement components are plotted. According to the chart illustrated in FIG. 4, the higher the number of failures, the greater the lack of required replacement components. The lack of required replacement components may indicate issues with maintenance and logistics documentation instructions or evidence of problems in the supply chain, for example, in addition to inherent component behavior. High incidences of failure, or high incidence of unavailable replacement components, may translate into overall system non-availability. According to various aspects of the current invention, a correlation between failures and unavailable replacement parts of specific components may trigger further investigation into engineering requirements deployment of the specific components and the overall supply chain, in order to prevent further catastrophic failures by, for example, providing more of the unavailable components in a manner that answers the need for these components without unduly increasing inventory and other maintenance costs.

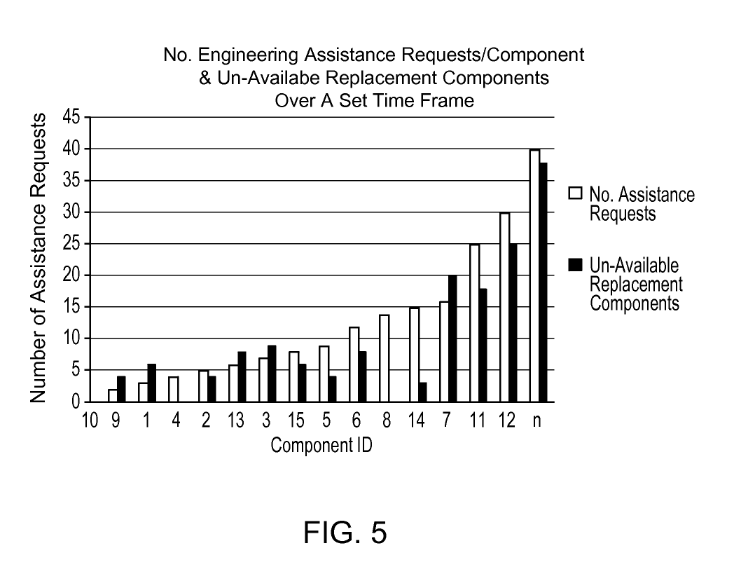

FIG. 5 is a chart correlating engineering assistance requests and demand for unavailable components that may be used in the evaluation of current failure trends and engineering instructions for repair, according to various aspects of the current invention. For each component identification (ID), both the number of engineering assistance requests and of unavailable replacement components are plotted, as applied to various technology areas such as the transportation industry, the manufacturing industry or any other appropriate industry that experiences equipment failure. The chart illustrated in FIG. 5 is similar to the charts illustrated in FIGS. 2, 3 and 4 in that it shows an exponential increase of engineering assistance requests for various components. According to the chart illustrated in FIG. 5, the higher the number of engineering assistance requests, the greater the lack of required replacement components. Accordingly, the lack of required replacement components may indicate emerging and future demand trends unsupported in the existing maintenance and logistics construct, evidence of problems, for example, in the supply chain. High incidences of engineering assistance requests or unavailable replacement components may generally translate into system non-availability and other adverse trends. A strong correlation between engineering assistance requests and unavailable components may be evidence of an imminent or upcoming failure, and may thus trigger a further investigation of engineering requirements deployment, and/or review of the overall supply chain. The inability to recognize these emerging and future trends early (in the absence of aspects of the current invention) further exacerbates negative system availability and support costs. Furthermore, unexpected failure and resulting unexpected loss of property or life may be indicated in these trends leading to a negative safety posture.

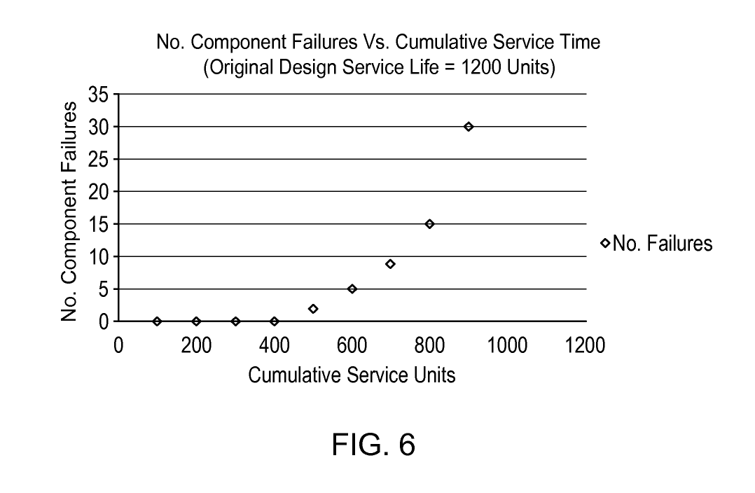

FIG. 6 is a chart illustrating a component failure plot that may be used in the evaluation of current failure trends, according to various aspects of the current invention, and illustrates increasing premature failure or degraded performance of a component during the component's original design life. The premature failure or degradation may be measured in any number of units, including time or cycles for various technology areas such as the transportation industry, the manufacturing industry or any other appropriate industry that experiences equipment failure. The trend illustrated in FIG. 6 for a single system or a fleet of systems, for example, indicates unscheduled maintenance events, which generally result in corresponding negative availability and support cost performance trends. Factors that contribute to the trend of FIG. 6 may include inherent design behavior or latent defects, inadequately deployed engineering requirements, system operation beyond intended limits, and other factors, for example. The data illustrated in FIG. 6 may trigger further investigation into engineering, logistics and other support function requirements and data. In the case of critical safety items, this type of trend may demand an immediate investigation, and may mandate changes in the existing maintenance and logistics plans. According to various aspects of the current invention, as the curve turns upwards towards the higher number of cumulative service units, beyond about 700 cumulative service units, for example, in a selected industry, maintenance actions may be initiated in order to predict an imminent catastrophic failure.

According to various aspects of the current invention, engineering requirements for maintenance and logistics requirements and historical data traceability are traced from engineering to maintenance, logistics and other functional support documentation and data. Compliance levels may be determined ranging from Fully Compliant to Omitted/Non-Compliant. Inadequate and non-compliant requirements deployment can result in missed or sub-optimized inspection and repairs, leading to lowered performance or premature system failure, as illustrated in FIGS. 2-6 above. As a result of unscheduled maintenance and demand for components undesirable trends for system availability and cost performance may increase. According to various aspects of the current invention, deployment requirements may be corrected throughout the documentation hierarchy, and corrective actions for sub-optimized parameters may be developed as appropriate to bring the system back into acceptable performance ranges by predicting imminent failure and taking appropriate actions to prevent such failure.

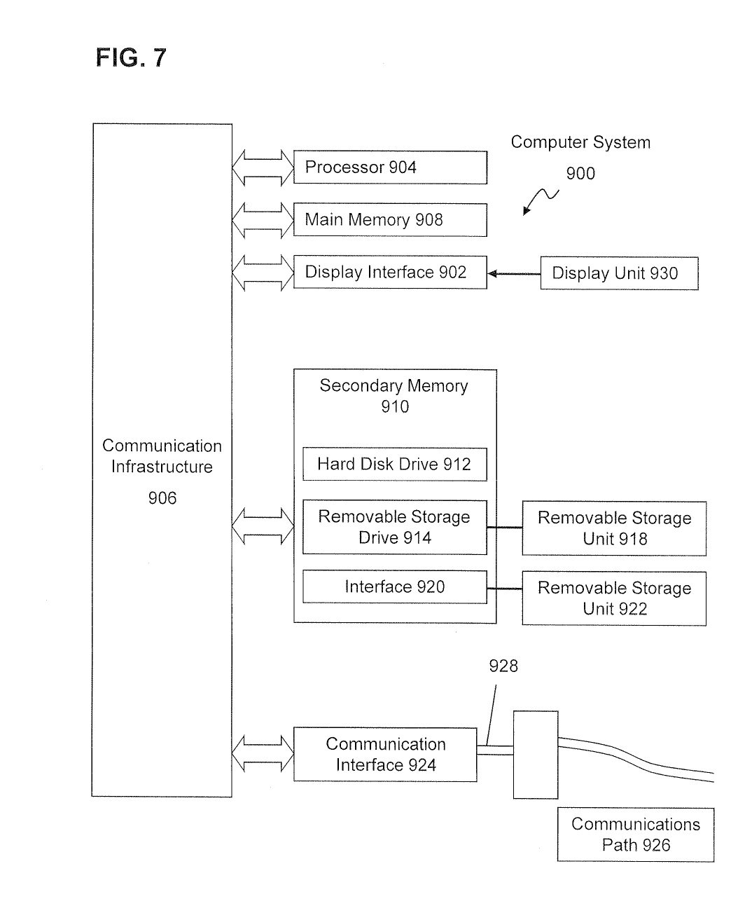

Various aspects of the current invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 7.

Computer system 900 includes one or more processors, such as processor 904. The processor 904 is connected to a communication infrastructure 906 (e.g., a communications bus, cross-over bar, or network). Various software features are described in terms of this exemplary computer system. After reading this description, it will become apparent to a person skilled in the relevant art(s) how to implement aspects of the invention using other computer systems and/or architectures. Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative variations, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. Aspects of the invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features in accordance with aspects of the present invention. Accordingly, such computer programs represent controllers of the computer system 900.

In variations where aspects of the invention are implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another variation, aspects of the invention are implemented primarily in hardware using, for example, hardware components, such as application specific integrated circuits (ASICs). Implementation of the hardware state machine so as to perform the functions described herein will be apparent to persons skilled in the relevant art(s). In yet another variation, aspects of the invention is implemented using a combination of both hardware and software.

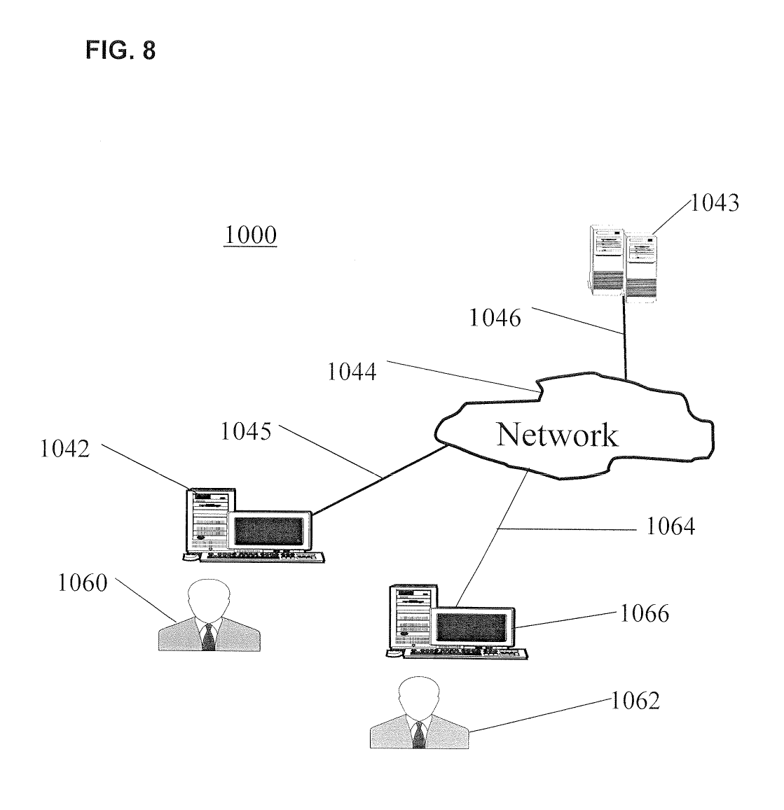

FIG. 8 shows a communication system 1000 usable in accordance with aspects of the present invention. The communication system 1000 includes one or more accessors 1060, 1062 (also referred to interchangeably herein as one or more “users”) and one or more terminals 1042, 1066. In one variation, data for use in accordance with aspects of the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another variation, the method and system according to aspects of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A computer-assisted method for increasing reliability of a system having a plurality of components, the computer including a processor and a data repository, the method comprising:
evaluating current failure trends of one or more of the components via the processor;
evaluating engineering instructions for repair resulting from a failure of the one or more components;
forecasting future failure trends based on the evaluated current failure trends; and
updating at least one of supply channels and maintenance and repair protocols based on the future failure trends and the evaluated engineering instructions.

2. The method of claim 1, further comprising:
determining previously unrecognized critical safety items;
updating the at least one of supply channels and maintenance and repair protocols based on the previously unrecognized critical safety items.

3. The method of claim 1, wherein evaluating the current failure trends comprises:
performing a Pareto analysis of failures across the system to determine a priority for investigating the one or more failed components.

4. The method of claim 1, wherein evaluating current failure trends comprises:
analyzing failure description for all components of the system.

5. The method of claim 1, wherein evaluating the engineering instructions comprises:
performing a traceability process that includes performing discreet inspections of the one or more components of the system.

6. The method of claim 1, wherein evaluating the engineering instructions includes:
comparing the engineering instructions to engineering requirements for satisfying original or extended design life of the one or more components.

7. The method of claim 1, wherein evaluating the current failure trends comprises:
performing a correlation analysis to identify current damage, demand and effectiveness of corrective action trends for the system.

8. The method of claim 7, wherein evaluating the current failure trends includes:
assessing current scheduled repairs and purchases of replacement items.

9. The method of claim 1, wherein updating the at least one of supply channels and maintenance and repair protocols comprises:
developing alternative scheduled repair and purchase plans for meeting current and projected system support requirements.

10. The method of claim 5, further comprising:
revising engineering, maintenance and logistics documentation for updating the at least one of supply channels and maintenance and repair protocols.

11. The method of claim 1, wherein evaluating the engineering instructions for repair comprises:
evaluating at least one of logistics data, procurement data, contracting data, repair data, overhaul data, packaging data, handling data, shipping data, and storage data.

12. The method of claim 1, wherein evaluating the engineering instructions for repair comprises evaluating at least one selected from the group consisting of:
specifications from system concept through development, prototype, test, production and fielding;
documents relative to requirements for maintaining performance throughout an intended service life of the system based on testing, modeling;
test, analysis and modeling reports;
updates based on field experience and system modifications; and
responses to maintenance, logistics and other requests for assistance.

13. The method of claim 11, wherein the logistics data comprises at least one selected from the group consisting of:
technical data including illustrated parts breakdown manuals or documents describing the system and the plurality of components;
instructions for required facilities for system storage, shipping, repair, and operations;
packaging, handling and storage requirements at many assembly levels;
training requirements for maintenance, operations, supply support and functional support activities;
instructions for personnel resources required for system operation and support;
information on design interfaces with other systems;
instructions on supply support and test equipment; and
maintenance planning data.

14. A system for increasing reliability of a system having a plurality of components, the system comprising:
a first evaluating module for evaluating current failure trends of one or more of the components;
a second evaluating module for evaluating engineering instructions for repair resulting from a failure of the one or more components;
a forecasting module for forecasting future failure trends based on the evaluated current failure trends; and
an updating module for updating at least one of supply channels and maintenance and repair protocols based on the future failure trends and the evaluated engineering instructions.

15. A system for increasing reliability of a system having a plurality of components, the system comprising:
a processor;
a user interface functioning via the processor; and
a repository accessible by the processor; wherein:
current failure trends of one or more of the components are evaluated;
engineering instructions for repair resulting from a failure of the one or more components are evaluated;
future failure trends are forecasted based on the evaluated current failure trends; and
at least one of supply channels and maintenance and repair protocols are updated based on the future failure trends and the evaluated engineering instructions.

16. The system of claim 15, wherein the processor is on a server that is coupled to a network.

17. The system of claim 16, wherein the network is the Internet.

18. The system of claim 16, wherein the server is coupled to a network via one of a wired connection, a wireless connection, and a fiber-optic connection.

19. The method of claim 1, wherein one or more of the updated at least one of supply channels and maintenance and repair protocols are displayed.
